(19) United States
(12) Patent Application Publication
(10) Pub. No.: US 2003/0150893 A1
(43) Pub. Date: Aug. 14, 2003

(54) Tractor tool caddy

(76) Inventor: Murray Deutchman, Barnesville, MD (US)

Correspondence Address: MURRAY L. DEUTCHMAN, 451 HUNGERFORD DR., ROCKVILLE, MD, 20838, US

(21) Appl. No.: 10/073,191

(22) Filed: Feb. 13, 2002

(51) Int. Cl. B60R 7/00; B60R 9/00; B60R 11/00

(52) U.S. Cl. 224/410; 224/572

(57) ABSTRACT

The Tractor Tool Caddy is a device that allows for carrying of small and medium sized tools and equipment on a riding mower or tractor or other similar vehicle while allowing the operator to keep his hands free to safely operate the mower or tractor. The tools and implements are held on the Tractor Tool Caddy by a number of devices, including “D” rings, loops, pockets and stretch straps. The Tractor Tool Caddy is secured to the mower or tractor by stretch straps which connect the Tractor Tool Caddy to parts of the mower or tractor with “S” hooks.

### 3. RELATED PATENT APPLICATIONS

The applicant believes that the following patents are related to the concept of the invention and may be deemed to be prior art:

| | |
|---|---|
| Patent No. 4773535 | Dated Sep. 27, 1988 |
| Patent No. 4993551 | Dated Feb. 19, 1991 |
| Patent No. 4126189 | Dated Nov. 21, 1978 |
| Patent No. 6179185 | Dated Jan. 30, 2001 |
| Patent No. 4369526 | Dated Jan. 25, 1983 |
| Patent No. 5791608 | Dated Aug. 11, 1998 |
| Patent No. 5385281 | Dated Jan. 31, 1995 |
| Patent No. 6152300 | Dated Nov. 28, 2000 |

Copies of all the above cited patents are attached hereto.

### 2. FEDERALLY SPONSORED RESEARCH STATEMENT

This invention is not the result of or associated with any federally sponsored research program.

### 4. BACKGROUND OF THE INVENTION

This invention is a tool holder and implements holder for use with a riding lawn mower, all-terrain vehicle (ATV) or tractor (hereinafter all referred to as the “mobile vehicle”). It is made from heavy-duty canvas with many pockets, hooks, attaching rings and straps. It sits on the hood or fender of the tractor or riding mower, attaches to the mobile vehicle and allows the operator of the mobile vehicle to transport tools and implements while operating the mobile vehicle. It eliminates the need to attach a trailer or cart to a mobile vehicle in order to carry tools and light implements while using a mobile vehicle. It solves the problem of how to safely and conveniently transport tools or light implements when riding on a mobile vehicle while maintaining both hands free to safely operate the mobile vehicle. The TRACTOR TOOL CADDY has pockets, clips, hangers and elastic and non-elastic straps to securely hold, secure and transport tools and light implements, leaving the hands of the operator free to control and steer the riding mower and tractor.

### 5. SUMMARY OF THE INVENTION

The invention is made from heavy duty canvas on which are attached, by heavy duty stitching, hooks, straps, rings and various devices to secure tools and light implements as well as other smaller bags, pouches or carriers for tools. The invention is placed over the hood or fender of the mobile vehicle and is attached to the mobile vehicle by elastic type straps which are secured by “S” hooks to the bottom of the hood, or the bottom of the mobile vehicle or to other parts of the mobile vehicle that are accessible to the use of “S” hooks. The generic design of the invention would be rectangular but because riding mower and tractor designs vary, an accommodation would be needed in design in some cases to conform to the different shapes and designs of hoods, fenders, etc. to make attachment of the TRACTOR TOOL CADDY compatible with each manufacturers' design. A generic design would be made for general use and would provide alternative methods of attachment depending on the design of the mobile vehicle. The invention is made sturdy enough to accommodate elastic straps on the hood by use of metal stays or strips sewn into the canvas.

### 6. DRAWING DESCRIPTIONS

FIG. No. 1: Full Tractor Tool Caddy Design with detail of attachment devices.

FIG. No. 2: Depiction of how the Tractor Tool Caddy will be used with a riding mower or tractor.

### 7. DETAILED DESCRIPTION OF THE INVENTION

The invention will be made from a sheet of heavy canvas (1). The generic model will be rectangular in shape, approximately 18 inches wide by 36″ long. It will be stitched all around the edge to provide a stable piece of material. The invention will drape across the hood of the mobile vehicle and hang down the sides of the hood. On the part of the invention that lies on top of the hood of the mobile vehicle, a metal or other rigid strip (2) (“the rigid strips) will be sown into the canvas (1) from underneath The rigid strips will run the width of the canvas to provide stability for attaching the stretch straps (sometimes referred to as “bungee” cords) on top of the invention.

At both ends of both rigid strips, on top of the invention, metal “D” rings (7) will be heavy stitched onto the canvas so that stretch straps with “S” hooks or snaps at each end can attach to the “D” rings (7). This stretch strap will attach to one of the “D” rings (7) at the end of a rigid strip (2)), pull over the tools and implements (such as a tool box, chain saw, drill, weed wacker, hand saw, etc.), and attach to a “D” ring (7) at the other end of the rigid strip (2). The tools or implements will be held in place by the tension of the stretch straps. The rigid strips (2) will prevent the canvas sheet (1) from bunching. Where necessary, to accommodate the design of a mobile vehicle manufacturer, ventilation holes will be cut into the invention on the top or sides.

At various locations around the canvas sheet (1), there will be attachment devices, such as “D” rings (7), straps (6), pockets (4) and loops (5) to provide additional locations to attach other tools or implements with snaps or “S” hooks or other clipping or hooking devices or to provide additional hook locations for the separately provided stretch straps to run across the top of the mobile vehicle or to act as attachment points for other tool pouches or bags.

In the generic model, pockets (4) will be placed on each side of the part of the invention that hangs down along the side of the mobile vehicle. The pockets (4) will be large enough to accommodate, nails, staples, bolts or small tools and cans or bottles of beverage.

On one side of the invention where it hangs down the side, short loops (5), will be fashioned and heavy stitched to hold tools such as hammers, clippers, or other tools with handles. On the other side of the invention, pockets of various sizes and shapes will be heavy stitched onto the invention, vertically, so that long handled tools, such as rakes, hoes, shovels, etc., can be transported. An additional horizontal strap (6) will be heavy stitched on the side of the invention where gloves or other tools or items needed can be hung or attached for transport. In some cases, pockets or bags of various sizes and shapes will be available as attachments to the invention to carry larger tools or implements.

The design and location of the pockets (4), loops (5), “D” rings (7), etc., will vary from model to model depending on the design or shape of the mobile vehicle. Copies of the individual model designs and shapes will be obtained from the mobile vehicle manufacturer to “custom” make the invention where needed.

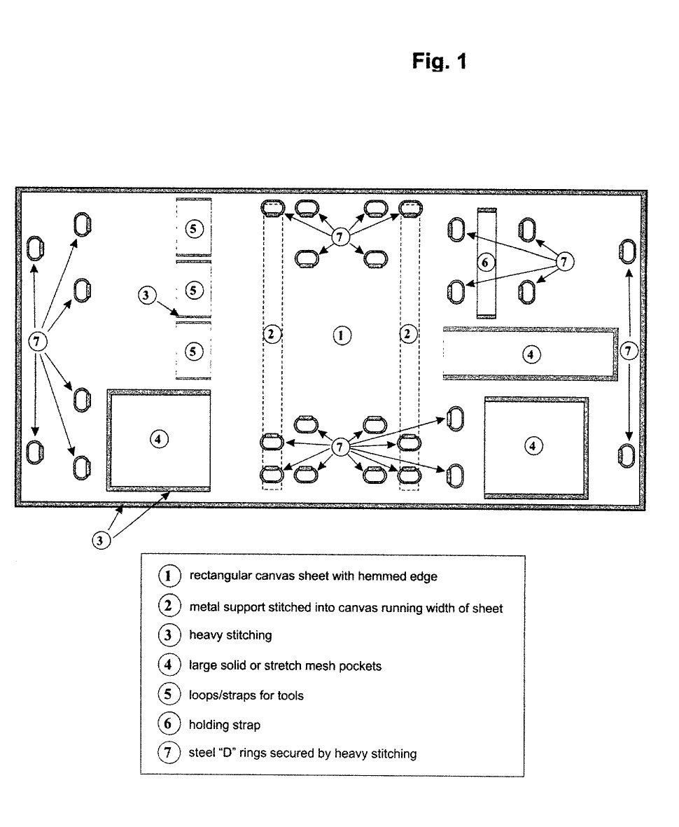

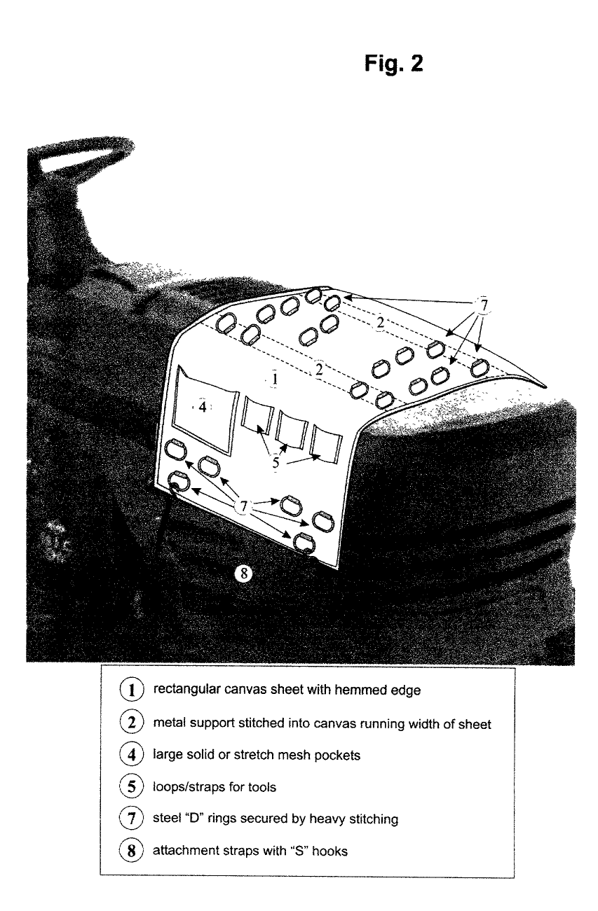

Secure attachment of the invention to the mobile vehicle is important. The invention will be attached to the mobile vehicle by stretch straps (8) [See FIG. 2] with “S” hooks at the ends. The “S” hooks will attach to the invention at “D” rings (7) located at the bottom of the sides of the invention that hang down the sides of the mobile vehicle. The stretch straps (8) will then be attached to the bottom of the hood of the mobile vehicle or to vent slits on the mobile vehicle or to any part of the mobile vehicle to which the “S” hooks can attach. If no such parts exist, then small holes can be drilled into a lower area of the side of the tractor on each side to accommodate the “S” hooks. Various sizes and sufficient numbers of stretch straps (8) will be provided with the invention to allow for secure attachment to the mobile vehicle.

To accommodate design differences in mobile vehicles, the actual shape of the invention may have to be modified and the location of the attachment devices or pockets changed, depending on the manufacturers' design of the hood area, but the basic physical components of the invention will be the same and the purposes for which it was designed will be served.

What I claim as my invention is:

A). A canvas tool and implement carrier designed to drape over the hood or fender of a mobile vehicle that allows the operator of the mobile vehicle to transport tools and implements held in pockets, by straps and by attachment to various rings and loops, while keeping both hands free to safely operate the mobile vehicle, the device comprised of:
a) a heavy duty canvas sheet (the “sheet”) generally rectangular in shape, heavy stitched all around the edges to provide a stable sheet of canvas;
b) the sheet of canvas is long enough to lie across the top of the mobile vehicle and drape down the sides of the mobile vehicle, but the exact size and shape can be modified during manufacture, to conform to the shape of any hood or fender area of any mobile vehicle;
c) attached to the sheet of canvas, by heavy duty threaded stitching, are metal “D” rings, pockets, loops and other devices in various patterns, to accommodate the attachment and carrying of tools and implements for secure transport and to provide for securing of the invention to the mobile vehicle;
d) sewn into the sheet are two metal or other rigid strips located in the area of the sheet that lays over the top of the hood, width-wise across the sheet, to provide stability for when stretch straps are attached to secure tools and implements to the hood of the tractor;
e) metal “D” rings are attached on top of the sheet, at both ends of the rigid strips for attachment of stretch straps with metal “S” hooks or spring hooks;
f) straps, loops, pockets and tool handle pockets are located along each side of the sheet where it drapes down the sides of the hood, large enough to hold various tools, nails, implements, gloves and a beverage container, the configuration of which will depend on the design of the hood of the mobile vehicle;
h) the sheet itself is attached to the tractor by use of stretch straps with “S” hooks at each end which hooks are attached to “D” rings located at the bottom of the sheet as it hangs down the side of the mobile vehicle and then to the bottom of the hood or to another lower part of the mobile vehicle.
